(19) United States
(12) Patent Application Publication
(10) Pub. No.: US 2013/0057468 A1
(43) Pub. Date: Mar. 7, 2013

(54) DATA OUTPUT DEVICE, DISPLAY DEVICE, DISPLAY METHOD AND REMOTE CONTROL DEVICE

(71) Applicants: Masanori Nakata, Chiyoda-ku (JP); Noriyuki Kushiro, Chiyoda-ku (JP); Yoshiaki Koizumi, Chiyoda-ku (JP); Takuya Mukai, Chiyoda-ku (JP)

(72) Inventors: Masanori Nakata, Chiyoda-ku (JP); Noriyuki Kushiro, Chiyoda-ku (JP); Yoshiaki Koizumi, Chiyoda-ku (JP); Takuya Mukai, Chiyoda-ku (JP)

(73) Assignee: MITSUBISHI ELECTRIC CORPORATION, Tokyo (JP)

(21) Appl. No.: 13/696,832

(22) PCT Filed: Jan. 28, 2011
(86) PCT No.: PCT/JP2011/051798

§ 371 Date: Nov. 8, 2012

(30) Foreign Application Priority Data
May 19, 2010 (JP) 2010-115106

(51) Int. Cl. G09G 5/00; G06K 9/36

(52) U.S. Cl. 345/156; 382/233; 345/204

(57) ABSTRACT

Unit data, which constitutes digital data is extracted as 8-bit units of parallel data by a control section and outputted to a buffer. Thereafter, in a process where the unit data is transmitted from a serial interface to a display unit, the unit data is converted to parallel data in a format required by the display unit. Thereby, it becomes unnecessary for the control section to perform processing of converting the digital data to a format required by the display unit. Consequently, the load on the control section is reduced.

### TECHNICAL FIELD

The present invention relates to a data output device, display device, display method and remote control device, and more particularly to a data output device that outputs data that defines a digital image, a display device that displays a digital image, a display method for displaying a digital image, and a remote control device that is provided with the display device.

### BACKGROUND ART

Facility equipment such as air-conditioning equipment that is installed in a factory or building operates in conjunction with a remote control device for operating that facility equipment. In addition to room temperature or the like being displayed on the liquid-crystal display of this kind of remote control device, a power transfer switch, a preset temperature change switch and the like are displayed (for example, refer to Patent Literature 1). A user is able to know an operating state of the air-conditioner device from the displayed information, and by touching the displayed switches, is able to perform operations such as turning on the air-conditioner, or changing the preset temperature.

### PRIOR ART LITERATURE

### Patent Literature

Patent Literature 1: Japanese Patent No. 3688721

### DISCLOSURE OF THE INVENTION

### Problems to be Solved by the Invention

In order to display information requested by the user on the liquid-crystal display of the remote control device, it is necessary to perform a process of converting digital data of an image to be displayed to a format specified for each liquid-crystal display (hereafter, referred to as conversion processing). Therefore, a load to perform this conversion processing is placed on a CPU (Central Processing Unit) of the device.

The present invention has been made in view of the above-mentioned circumstances, and an object of the present invention is to reduce the load on a control section of the CPU by making hardware to execute processing that is to be executed when displaying a digital image.

### Means for Solving the Problems

In order to accomplish the object described above, a data output device of the present invention is provided with:
a extraction means for extracting data that defines a digital image as first parallel data;
a transmission means for transmitting the extracted data one bit at a time;
a receiving means for receiving the transmitted data; and
a conversion means for generating second parallel data by converting the received data to a plurality of bits of data for each one bit of data.

### Efficats of the Invention

According to the present invention, processing to be executed on the digital image being displayed can be executed by hardware, so the load on the CPU is reduced.

### BRIEF DESCRIPTION OF DRAWINGS

FIG. 1 is a block diagram of an air-conditioning system in accordance with a first embodiment;

FIG. 2 is a block diagram of a control unit and a display unit;

FIG. 3 is a drawing schematically illustrating an example of digital data;

FIG. 4 is a drawing illustrating eight unit data that were extracted by a control section;

FIG. 5 is a drawing schematically illustrating outputted unit data;

FIG. 6 is a block diagram roughly illustrating a configuration of a display controller;

FIG. 7 is a drawing for explaining the operation of a flip-flop circuit;

FIG. 8 is a drawing schematically illustrating 16-bit parallel data that is outputted from a buffer circuit;

FIG. 9 is a drawing illustrating a relationship between the brightness of pixels constituting a digital image and unit data;

FIG. 10 is a drawing illustrating eight unit data that were extracted by the control section;

FIG. 11 is a drawing schematically illustrating outputted unit data;

FIG. 12 is a block diagram roughly illustrating a configuration of a display controller of a second embodiment of the present invention;

FIG. 13 is a drawing schematically illustrating 16-bit parallel data that is outputted from the buffer circuit.

FIG. 14 is a drawing for explaining a procedure for inserting dummy data;

FIG. 15 is a drawing for explaining a procedure for inserting dummy data;

FIG. 16 is a drawing for explaining a variation of a display controller;

FIG. 17 is a drawing for explaining a variation of a display controller;

FIG. 18 is a drawing for explaining a variation of data that is outputted from a serial interface;

FIG. 19 is a drawing for explaining a variation of data that is outputted from a serial interface;

FIG. 20 is a drawing illustrating a variation of a control unit;

FIG. 21 is a drawing illustrating a variation of a control unit;

FIG. 22 is a drawing illustrating a variation of a display controller; and

FIG. 23 is a drawing illustrating a variation of a display controller.

### MODE FOR CARRYING OUT THE INVENTION

### First Embodiment

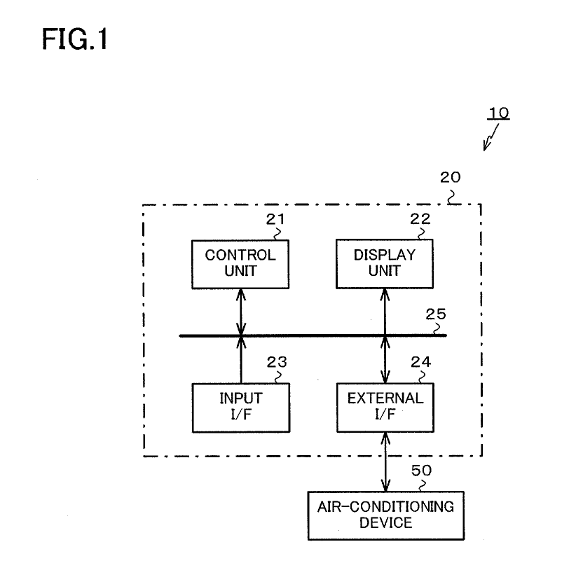

In the following, a first embodiment of the present invention will be explained with reference to drawings. FIG. 1 is a block diagram illustrating a schematic configuration of an air-conditioning system 10 of the embodiment. The air-conditioning system 10 is a system that keeps the temperature and humidity in a room constant. As illustrated in FIG. 1, this air-conditioning system 10 has an air-conditioning device 50, and a remote control device 20 that is connected to the air-conditioning device 50.

The air-conditioning device 50 has, for example, a compressor, a heater, an electric fan and the like. Based on an instruction that the remote control device 20 relays, the air-conditioning device 50 discharges air heated or cooled to a predetermined temperature.

The remote control device 20 receives an instruction from a user, for example, and notifies the air-conditioning device 50 of that instruction. Moreover, the remote control device 20 receives information such as the operating status of each component constituting the air-conditioning device 50, and displays images based on the received information.

As illustrated in FIG. 1, this remote control device 20 has a control unit 21, a display unit 22, an input interface 23, an external interface 24, and a bus 25 that connects the each component described above.

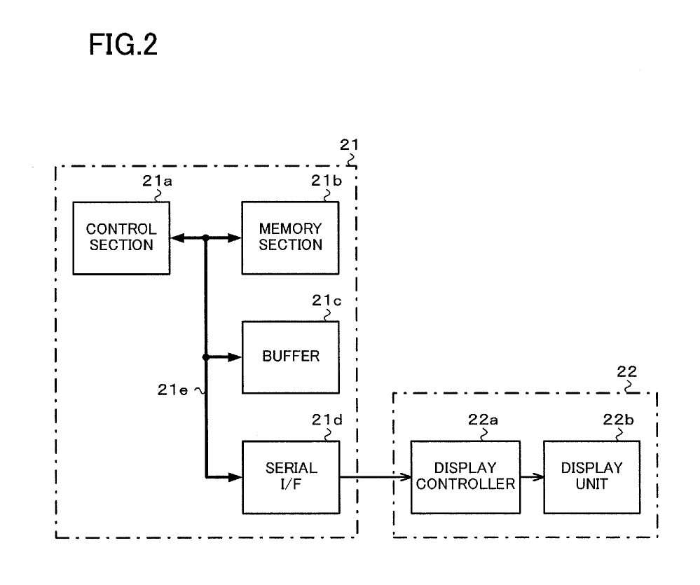

FIG. 2 is a block diagram of the control unit 21 and the display unit 22. The control unit 21 is configured as an IC chip on which an integrated circuit is packaged in ceramic or the like. As illustrated in FIG. 2, the control unit 21 has a control section 21a, a memory section 21b, a buffer 21c, and a serial interface 21d that are mutually connected by a bus 21e.

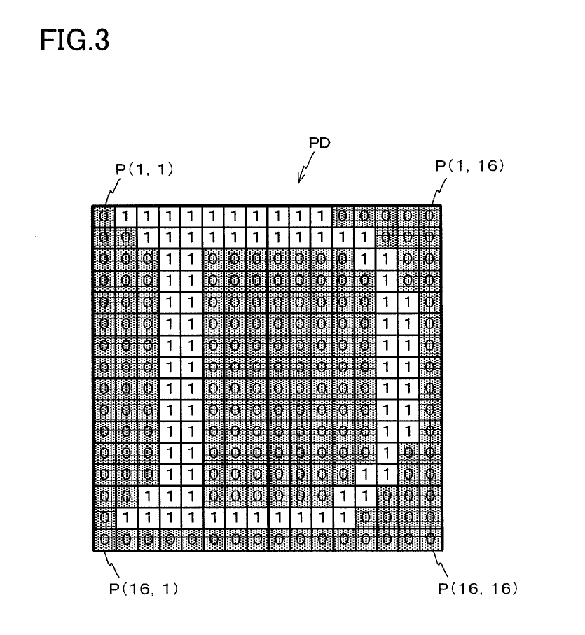

The memory section 21b has a VRAM (Video Random Access Memory). Digital data PD for digital images that are displayed on the display unit 22 is stored in the memory section 21b. FIG. 3 is a drawing schematically illustrating one example of digital data PD. This digital data PD is data that is based on a monochrome binary image that has high-brightness pixels having high brightness, and low-brightness pixels having low brightness. As illustrated in FIG. 3, the digital data PD is composed of 1-bit unit data P(x, y) that is arranged in a 16 row by 16 column matrix.

Here, x is an integer from 1 to 16, and y is an integer from 1 to 16. Moreover, in FIG. 3, the unit data P(x, y) that is assigned to low-brightness pixels is colored and illustrated. A value of the colored and illustrated unit data P(x, y) is 0. Furthermore, a value of the unit data P(x, y) that is assigned to high-brightness pixels is 1.

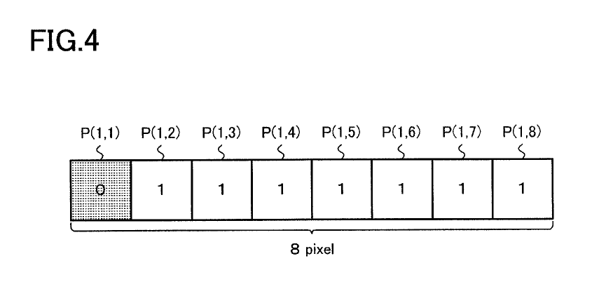

Returning to FIG. 2, the control section 21a extracts the unit data P(x, y) constituting the digital data PD that is stored in the memory section 21b by reading the data as parallel data in 8-bit units, and outputs that data to the buffer 21c. FIG. 4 is a drawing illustrating unit data P(x, y) that corresponds to eight pixels that are extracted by the control section 21a. As can be seen by referencing FIG. 4, the control section 21a first extracts eight unit data P(1, 1) to P(1, 8), then in order after that extracts unit data P(1, 9) to P(1, 16), P(2, 1) to P(2, 8), . . . , P(16, 9) to P(16, 16). Then, the control section 21a sequentially outputs the extracted unit data P(x, y) to the buffer 21c.

The buffer 21c is configured, for example, with a volatile memory or a memory circuit, and chronologically stores unit data P(x, y). The buffer 21c, according to a request from the serial interface 21d, then sequentially outputs unit data P(x, y) to the serial interface 21d.

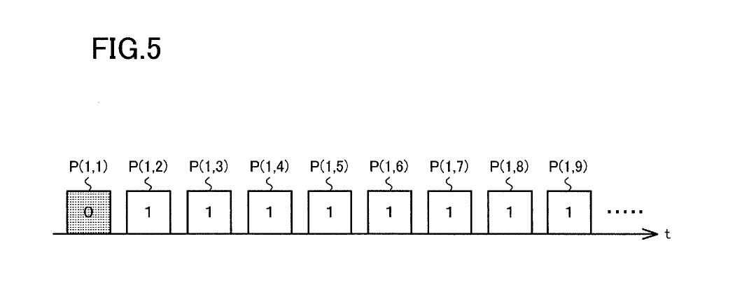

The serial interface 21d reads unit data P(x, y) that is stored in the buffer 21c. The serial interface 21d then outputs the read unit data P(x, y) to the display unit 22. As a result, unit data P(1, 1), P(1, 2), . . . , P(16, 16) such as is schematically illustrated in FIG. 5, for example, is serially and chronologically outputted to the display unit 22.

As illustrated in FIG. 2, the display unit 22 has a display controller 22a and a display unit 22b.

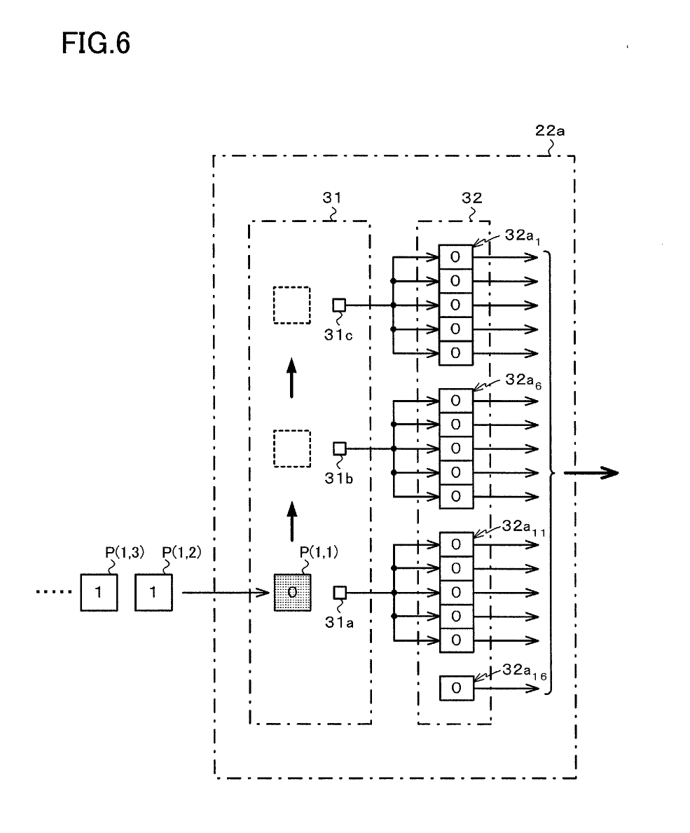

FIG. 6 is a block diagram roughly illustrating a configuration of the display controller 22a. As illustrated in FIG. 6, the display controller 22a has a flip-flop circuit 31 and a buffer circuit 32.

The flip-flop circuit 31 has three output stages 31a, 31b, and 31c. In this flip-flop circuit 31, when the unit data P(1, 1) that was outputted from the serial interface 21d is inputted, first, as illustrated in FIG. 6, that unit data P(1, 1) is set in the output stage 31a.

Next, when the unit data P(1, 2) is inputted, the unit data P(1, 1) that has been set in the output stage 31a is shifted to the output stage 31b. At the same time, the unit data P(1, 2) is set in the output stage 31a.

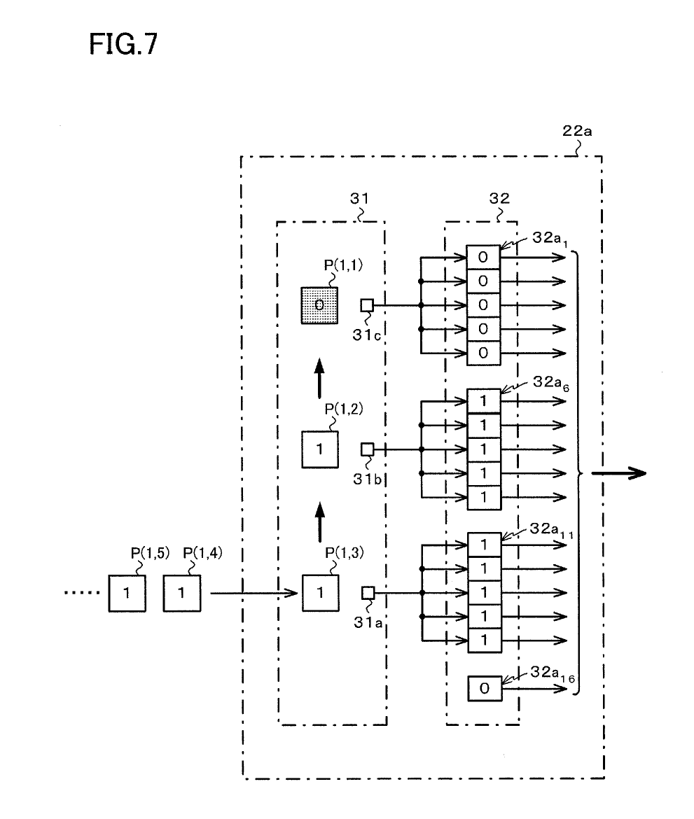

Next, when the unit data P(1, 3) is inputted, as can be seen by referencing FIG. 7, the unit data P(1, 1) that has been set in the output stage 31b is shifted to the output state 31c, and the unit data P(1, 2) that has been set in the output stage 31a is set in the output stage 31b. At the same time, the unit data P(1, 3) is set in the output stage 31a. As a result, unit data P(x, y) is set in all of the three output stages 31a, 31b and 31c that are provided in the flip-flop circuit 31.

Next, when the unit data P(1, 4) is inputted, the unit data P(1, 1) that has been set in the output stage 31c is reset. The unit data P(1, 2) that has been set in the output stage 31b is shifted to the output stage 31c, and the unit data P(1, 3) that has been set in the output stage 31a is shifted to the output stage 31b. At the same time, the unit data P(1, 4) is set in the output stage 31a. In the flip-flop circuit 31, each time that unit data P(x, y) is inputted, the operation mentioned above is repeatedly executed.

The buffer circuit 32, as illustrated in FIG. 6, has 16 output stages 32a₁ to 32a₁₆. The output stages 32a₁ to 32a₅ of the buffer circuit 32 are connected to the output stage 31c of the flip-flop circuit 31. Moreover, the output stages 32a₆ to 32a₁₀ of the buffer circuit 32 are connected to the output stage 31b of the flip-flop circuit 31. Furthermore, the output stages 32a₁₁ to 32a₁₅ of the buffer circuit 32 are connected to the output stage 31a of the flip-flop circuit 31.

Unit data P(x, y) that is equivalent to the unit data P(x, y) that is set in the corresponding output stages 31a, 31b and 31c of the flip-flop circuit 31 is set in the output stages 32a₁ to 32a₁₅ of the buffer circuit 32. Dummy data DD having a value of 1 is set in the output stage 32a₁₆.

For example, as illustrated in FIG. 7, when the unit data P(1, 1) is set in the output stage 31c of the flip-flop circuit 31, unit data P(1, 1) is set in each of the output stages 32a₁ to 32a₅ of the buffer circuit 32. Similarly, when the unit data P(1, 2) is set in the output stage 31b of the flip-flop circuit 31, the unit data P(1, 2) is set in each of the output stages 32a₆ to 32a₁₀ of the buffer circuit 32. Furthermore, when the unit data P(1, 3) is set in the output stage 31a of the flip-flop circuit 31, the unit data P(1, 3) is set in each of the output stages 32a₁₁ to 32a₁₅ of the buffer circuit 32.

The buffer circuit 32 outputs the unit data P(x, y) and the dummy data DD that have been set in the output stages 32a₁ to 32a₁₆ each time that three unit data P(x, y) are inputted to flip-flop circuit 31.

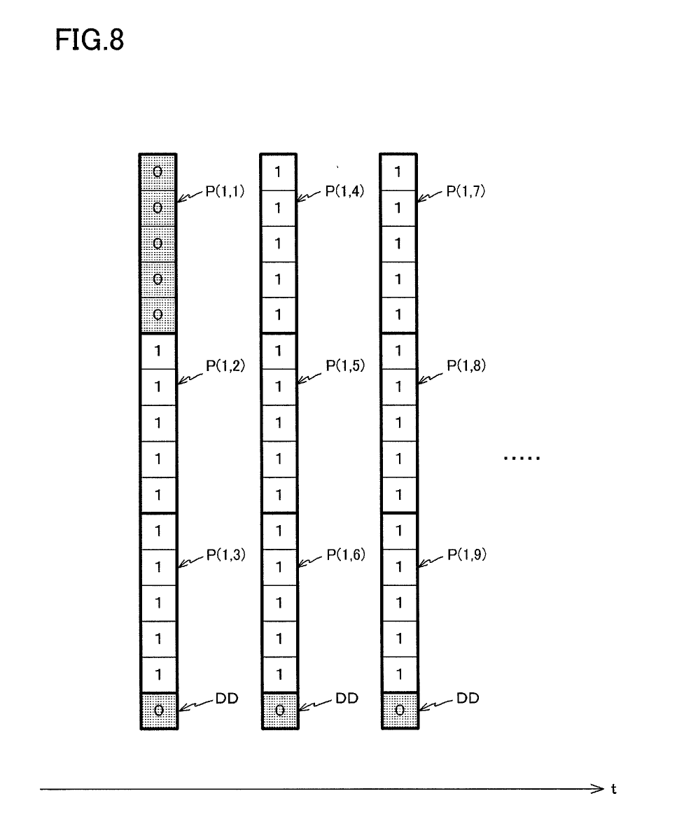

FIG. 8 is a drawing schematically illustrating 16-bit parallel data that is outputted from the buffer circuit 32. As can be seen by referencing FIG. 8, first, parallel data that is composed of five unit data P(1, 1), five unit data P(1, 2), five unit data P(1, 3) and dummy data DD having a value 0 is outputted from the buffer circuit 32. Next, parallel data that is composed of five unit data P(1, 4), five unit data P(1, 5), five unit data P(1, 6) and dummy data DD having a value 0 is outputted. After that, the buffer circuit 32 sequentially outputs 16-bit parallel data as mentioned above.

Returning to FIG. 2, when parallel data is outputted from the buffer circuit 32, the display unit 22b sequentially stores that parallel data in an internal memory. As a result, digital data that is equivalent to the digital data PD illustrated in FIG. 3 is stored in the internal memory of the display unit 22b. The display unit 22b, then displays an image that is defined by the digital data that is stored in the internal memory.

As explained above, in the embodiment, the unit data P(x, y) constituting the digital data PD is extracted as parallel data in 8-bit units by the control section 21a, and outputted to the buffer 21c. After that, in the process of transmitting the unit data P(x, y) to the display unit 22b from the serial interface 21d, that unit data P(x, y) is converted to parallel data in a format required by the display unit 22b. Therefore, the control section 21a does not need to perform processing to convert the digital data PD to a format required by the display unit 22b. Consequently, the load on the control section 21a is reduced.

Moreover, the control section 21a is able to execute other processing by the amount the load was reduced. Therefore, the processing performance of the entire system is improved.

In this embodiment, after the unit data P(x, y) constituting the digital data has been outputted by the control section 21a to the buffer 21c, that unit data P(x, y) is converted to a format required by the display unit 22b by hardware such as the serial interface 21d or display controller 22a. Therefore, it is possible to make the serial interface 21d or the like to operate by a clock that is obtained, for example, by multiplying by eight a clock that regulates the operation of the control section 21a. As a result, it is possible to perform communication between the control unit 21 and the display unit 22 in a short period of time.

In the above embodiment, a case was explained where 1-bit unit data P(x, y) is converted to 5-bit unit data P(x, y). The invention is not limited to this, and 1-bit unit data P(x, y) can also be converted to unit data P(x, y) having a desired number of bits such as 3 bits or 8 bits. In this case, this conversion can be achieved by adjusting the number of output stages 32a of the buffer circuit 32 that is connected to the output stages 31a, 31b, and 31c of the flip-flop circuit 32.

### Second Embodiment

Next, the control unit 21 and the display unit 22 of the second embodiment of the present invention will be explained. In the second embodiment, digital data PD of a digital image that is composed of pixels having four gradations is transmitted between the control unit 21 and display unit 22.

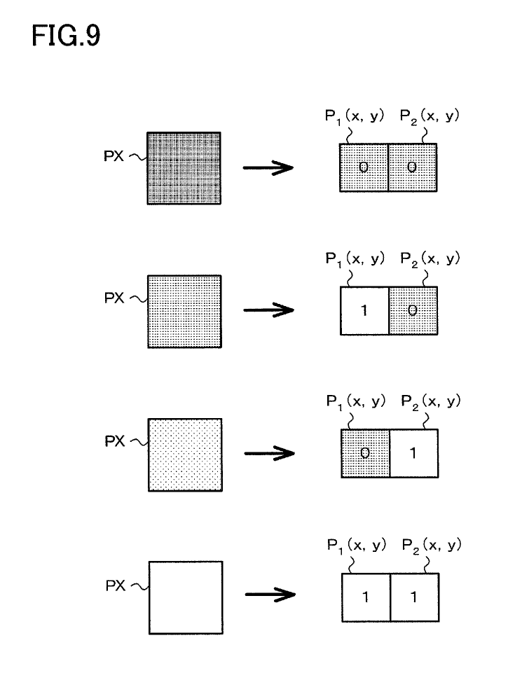

FIG. 9 is a drawing illustrating the relationship between the brightness of pixels PX constituting a digital image and the unit data P(x, y). As illustrated in FIG. 9 two kinds of unit data P₁(x, y) and P₂(x, y) are assigned to the pixels PX. The brightness of the pixels PX is regulated according to the two kinds of unit data P₁(x, y) and P₂(x, y).

The brightness of the pixels PX, for example, include a first brightness according to one set of unit data P₁ and P₂ having a value of 0, a second brightness for unit data P₁ having a value of 1 and unit data P₂ having a value of 0, a third brightness for unit data P1 having a value of 0 and unit data P₂ having a value of 1, and a fourth brightness for a set of unit data P₁ and P₂ having a value of 1. As can be seen from referencing FIG. 9, the value of the brightness is higher in the order of the fourth brightness, third brightness, second brightness and first brightness.

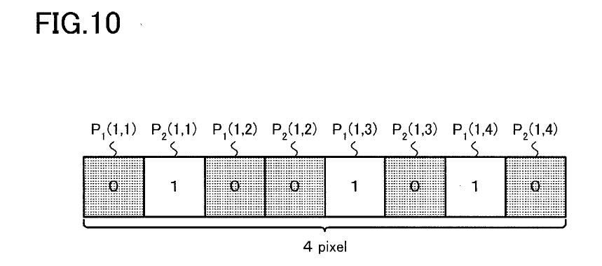

The control section 21a extracts unit data Pₖ(x, y) constituting digital data PD that is stored in the memory section 21b by reading the data as parallel data in 8-bit units, and outputs that data to the buffer 21c. FIG. 10 is a drawing illustrating the eight unit data Pₖ(x, y) that are extracted by the control section 21a. As illustrated in FIG. 10, the control section 21a extracts eight unit data Pₖ(1, 1), Pₖ(1, 2), Pₖ(1, 3), and Pₖ(1, 4) for four pixels, then after that extracts in order Pₖ(1, 5) to Pₖ(1, 8), . . . , Pₖ(16, 13) to Pₖ(16, 16). Then, the control section 21a outputs the extracted unit data in order to the buffer 21c. Here, k is 1 or 2.

The buffer 21c chronologically stores unit data Pₖ(x, y). Then the buffer 21c sequentially outputs unit data Pₖ(x, y) to the serial interface 21d according to a request from the serial interface 21d.

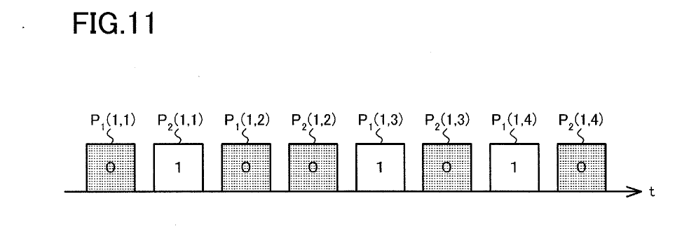

The serial interface 21d reads the unit data Pₖ(x, y) that is stored in the buffer 21c. The serial interface 21d then outputs the read unit data Pₖ(x, y) to the display unit 22. As a result, as is schematically illustrated in FIG. 11, unit data P₁(1, 1), P₂(1, 1), P₁(1, 2), P₂(1, 2), . . . , P₁(16, 16), and P₂(16, 16) are serially outputted to the display unit 22.

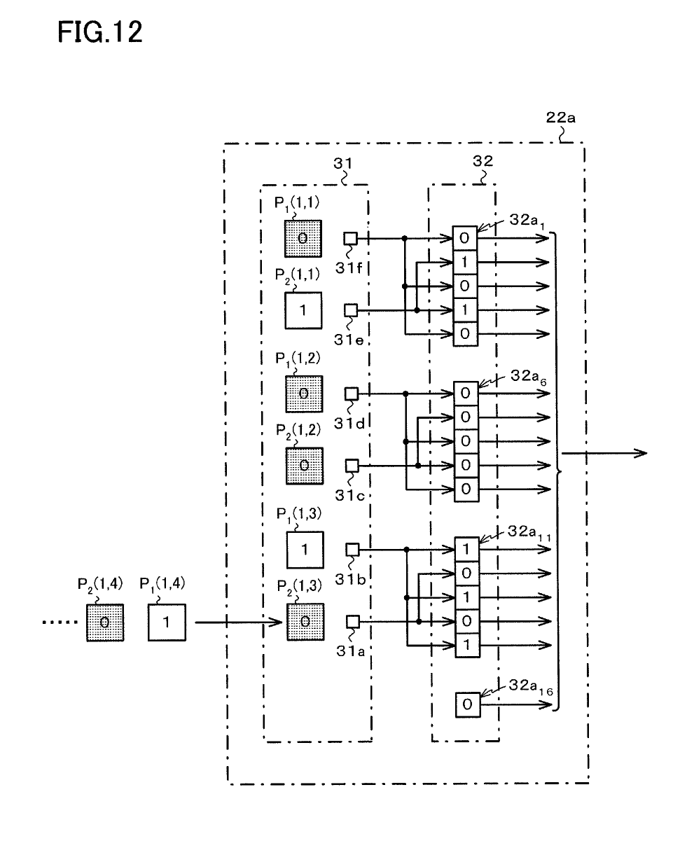

FIG. 12 is a block diagram roughly illustrating a configuration of the display controller 22a. As illustrated in FIG. 12, the display controller 22a has the flip-flop circuit 31 and the buffer circuit 32.

The flip-flop circuit 31 has six output stages 31a to 31f. The output stage 31a is connected to the output stages 32a₁₂ and 32a₁₄ of the buffer circuit 32. The output stage 31b is connected to the output stages 32a₁₁, 32a₁₃ and 32a₁₅ of the buffer circuit 32. The output stage 31c is connected to the output stages 32a₇ and 32a₉ of the buffer circuit 32. The output stage 31d is connected to the output stages 32a₆, 32a₈, and 32a₁₀ of the buffer circuit 32. The output stage 31e is connected to the output stages 32a₂ and 32a₄ of the buffer circuit 32. The output stage 31f is connected to the output stages 32a₁, 32a₃ and 32a₅ of the buffer circuit 32.

Therefore, as illustrated in FIG. 12, when unit data P₁(1, 1), P₂(1, 1), P₁(1, 2), P₂(1, 2), P₁(1, 3), and P₂(1, 3) are respectively set in the output stages 31f, 31e, 31d, 31c, 31b, and 31a of the flip-flop circuit 31, unit data Pₖ(x, y) that is equivalent to the unit data Pₖ(x, y) that has been set in the corresponding output stages 31a to 31f of the flip-flop circuit 31 is set in the output stages 32a₁ to 32a₁₅ of the buffer circuit 32. Moreover, dummy data DD having a value of 1 is set in the output stage 32a₁₆ of the buffer circuit 32.

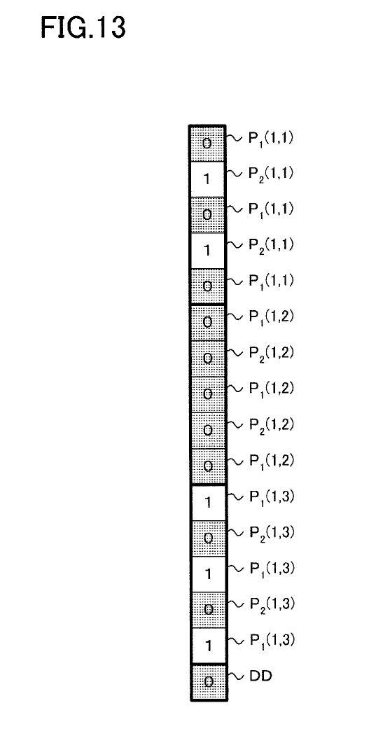

The buffer circuit 32 outputs the unit data P(x, y) that has been set in the output stages 32a₁ to 32a₁₆ and the dummy data DD each time that 6 unit Pₖ(x, y) are inputted to the flip-flop circuit 31. As a result, as illustrated in FIG. 13, 16-bit parallel data that is composed of unit data P₁(1, 1), P₂(1, 1), P₁(1, 2), P₂(1, 2), P₁(1, 3), P₂(1, 3) and dummy data DD that are arranged in parallel is outputted from the buffer circuit 32. After that, 16-bit parallel data that is composed of unit data P₁(x, y), P₂(x, y) and dummy data DD is outputted in order from the buffer circuit 32.

When parallel data is outputted from the buffer circuit 32, the display unit 22b sequentially stores that parallel data in an internal memory. As a result, digital data that is equivalent to the digital data PD that has been stored in the memory section 21b is stored in the internal memory of the display unit 22b. The display unit 22b displays an image defined by the digital data that has been stored in the internal memory.

As explained above, in the embodiment, unit data Pₖ(x, y) constituting the digital data PD is extracted as parallel data in 8-bit units, and outputted to the buffer 21c by the control section 21a. After that, during the process of the unit data Pₖ(x, y) being transmitted from the serial interface 21d to the display unit 22b, that unit data Pₖ(x, y) is converted to parallel data in a format required by the display unit 22b. Therefore, the control section 21a does not need to perform processing to convert the digital data PD to a format required by the display unit 22b. Consequently, the load on the control section 21a is reduced.

The control section 21a is able to execute other processing by the amount that the load is reduced. Therefore, the processing performance of the entire system is improved.

In this embodiment, after the unit data Pₖ(x, y) constituting the digital data has been outputted to the buffer 21c by the control section 21a, the unit data Pₖ(x, y) is converted to a format that is required by the display unit 22b by hardware such as the serial interface 21d or display controller 22a. Therefore, it is possible to make the serial interface 21d or the like to operate by a clock that is obtained, for example, by multiplying by eight a clock that regulates the operation of the control section 21a. As a result, it is possible to perform communication between the control unit 21 and the display unit 22 in a short period of time.

In the embodiment, the digital image has four gradations, and the brightness of the pixels PX constituting the digital image is defined by 2-bit unit data Pₖ(x, y). The invention is not limited to this, and for example, digital image may have 16 gradations, and the brightness of the pixels PX of the digital image may be defined by 4-bit unit data Pₖ(x, y). Moreover, the digital image may have 256 gradations, and the brightness of the pixels PX constituting the digital image may be defined by 8-bit unit data Pₖ(x, y). In this case, dummy data can be inserted into the output stages 32a₁₄, 32a₁₅, and 32a₁₆ of the buffer circuit 32, or alternatively these output stages 32a₁₄, 32a₁₅, and 32a₁₆ cannot be used.

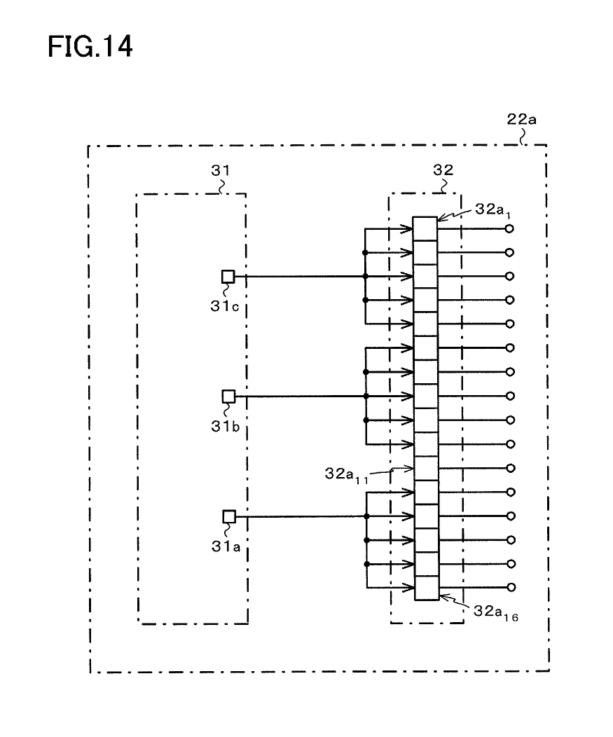

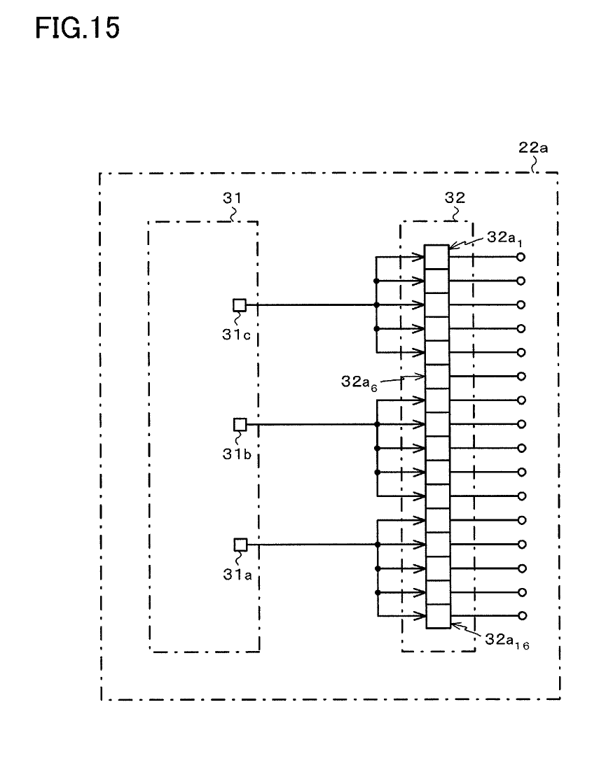

Embodiments of the present invention were explained above, however, the present invention is not limited by the embodiments above. For example, in the embodiments above, as illustrated in FIG. 6, the case was explained where dummy data is set in the output stage 32a₁₆ of the buffer circuit 32. The invention is not limited to this, and, for example, as can be seen by referencing FIGS. 14 and 15, dummy data may also be set in an output stage other than the output stage 32a₁₆, for example, the output stage 32a₁, output stage 32a₆, output stage 32a₁₁ and the like. Moreover, the dummy data may have a value of 1.

In this case, the lines between the output stages 31a, 31b, and 31c of the flip-flop circuit 31 and the buffer circuit 32 illustrated in FIGS. 14 and 15 are switched by a selector, and when necessary, the output stages 32a₁ to 32a₁₆ in which dummy data DD are set can be changed.

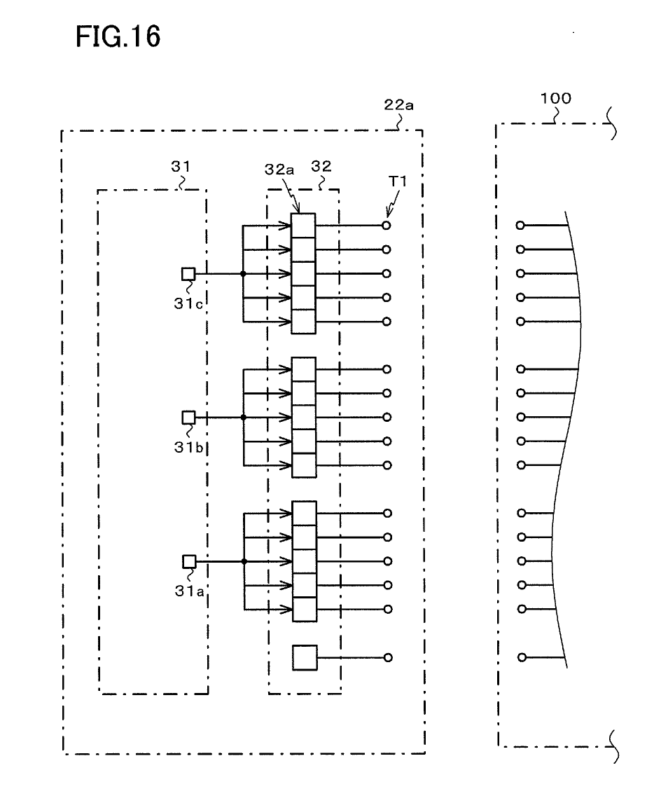

Moreover, as can be seen by referencing FIG. 16, the output lines that extend from the output stage 32a of the buffer circuit 32 in order to output unit data may be connected to a terminal T1 that can be connected to an external device. In that case, it is possible to run the output lines according to a standard of a unit 100 that is connected to the display controller 22a.

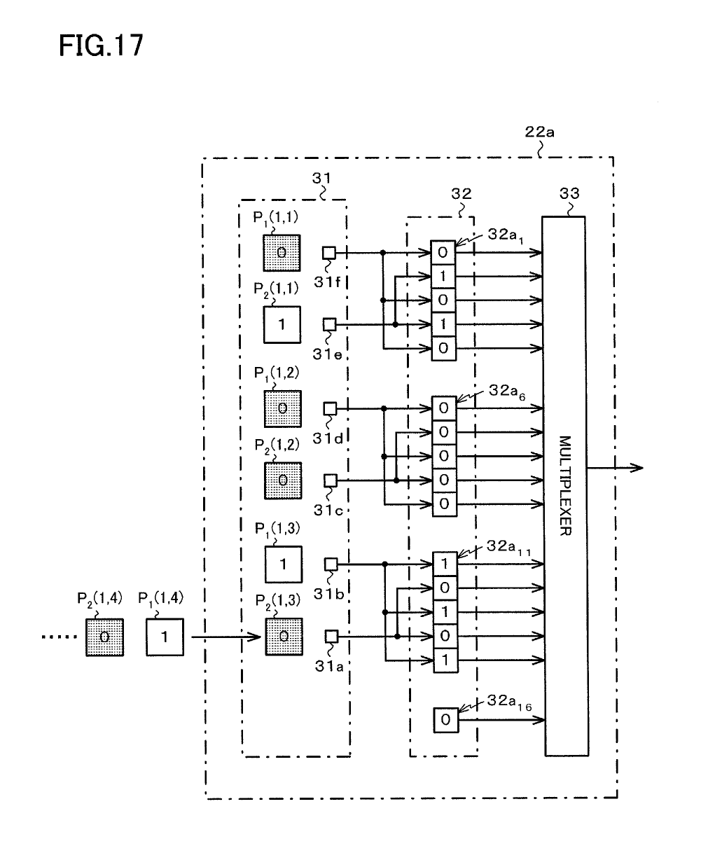

Moreover, as illustrated in FIG. 17, the output from the buffer circuit 32 can be output by way of a multiplexer 33. For example, in the embodiments above, after unit data P(x, y) constituting the digital data has been outputted by the control section 21a, conversion of the format of the unit data P(x, y) is executed independent of the control section 21a. Therefore, in order to output the converted unit data in 8-bit units for example, it is necessary that the timing for outputting the unit data be set according to the external device or the like.

In this case, by using a multiplexer 33, it is possible to alternately output 8-bit data from the output stages 32a₁ to 32a₈ and the 8-bit data from output stages 32a₉ to 32a₁₆ of the buffer circuit 32 in synchronization with a clock signal for regulating the output timing according to the external device or the like. As a result, 8-bit data is outputted at a predetermined timing to the external device or the like. Therefore, it is possible to output parallel data at a desired timing even when the control section 21a and hardware such as the serial interface 21d or display controller 22a are made to operate respectively independently.

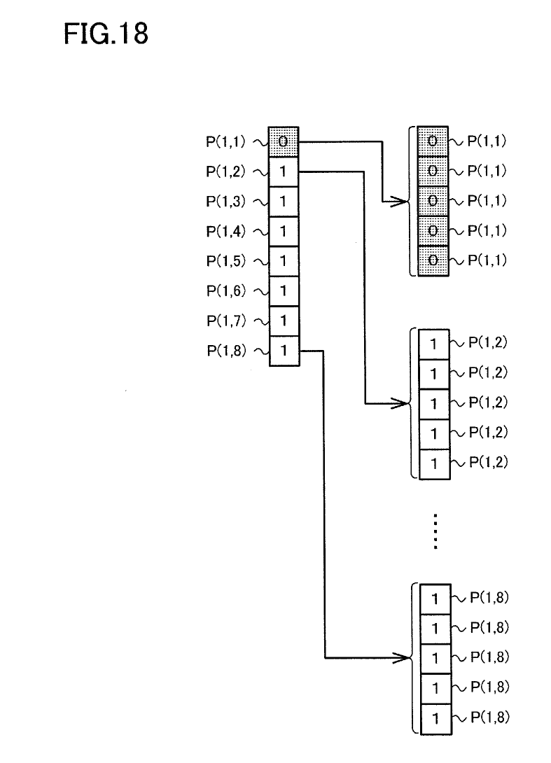

In the embodiments above, the case was explained where after unit data has been outputted from the serial interface 21d of the control unit 21, the data is converted to unit data having a plurality of bits. The invention is not limited to this, and it is also possible in the case where 1-bit unit data is assigned to one pixel to convert the unit data to parallel data having a plurality of bits (5 bits) beforehand as illustrated in FIG. 18 before the unit data is outputted from the serial interface 21d.

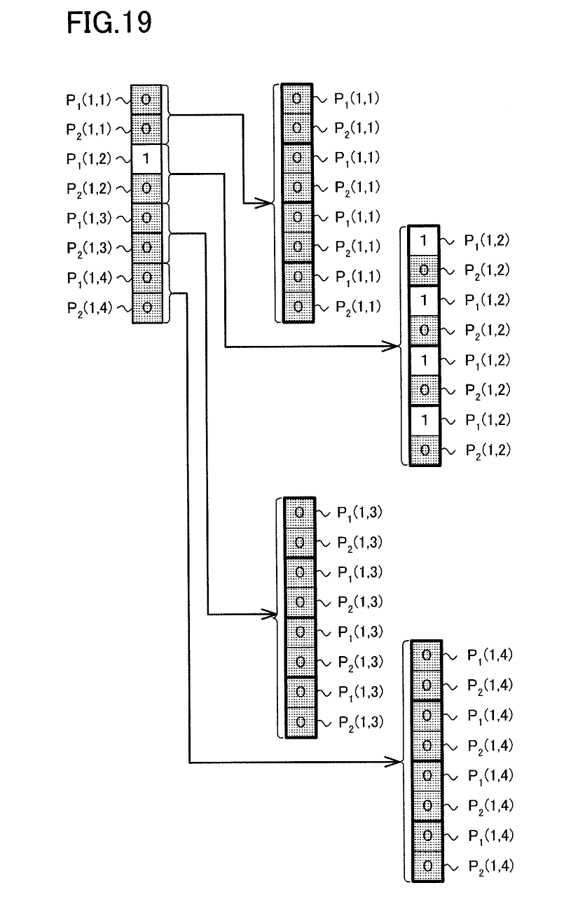

Moreover, when 2-bit unit data is assigned to each of the pixels constituting a digital image, it is also possible to convert that unit data to data having a plurality of bits beforehand as illustrated in FIG. 19 before the unit data is outputted from the serial interface 21d. In this case, by arranging the unit data in parallel for each 2-bit unit data, it is possible to convert 2-bit parallel data to parallel data having a plurality of bits (8 bits).

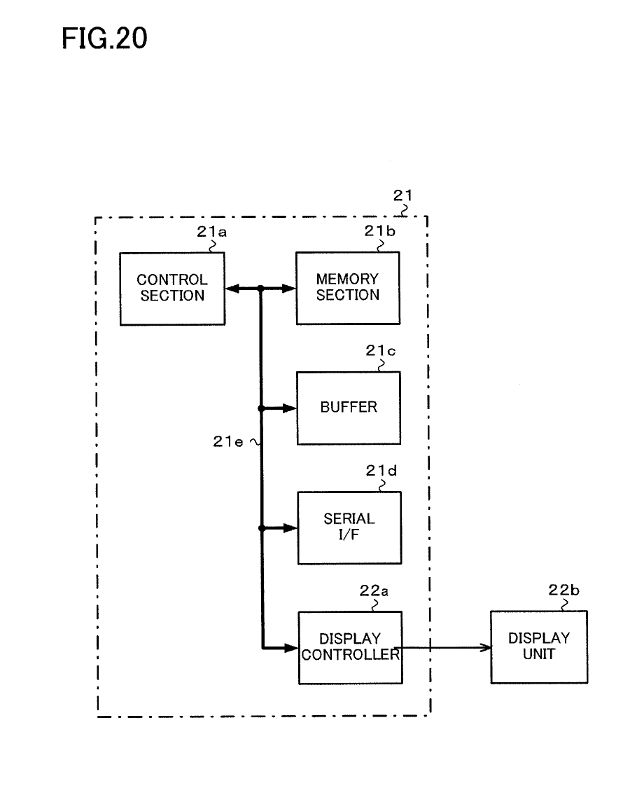

In the embodiments above, the case was explained where the flip-flop circuit 31 and the like are provided in the display controller 22a. The invention is not limited to this, and it is also possible, for example, to provide the display controller 22a or the corresponding unit in the control unit 21 as illustrated in FIG. 20.

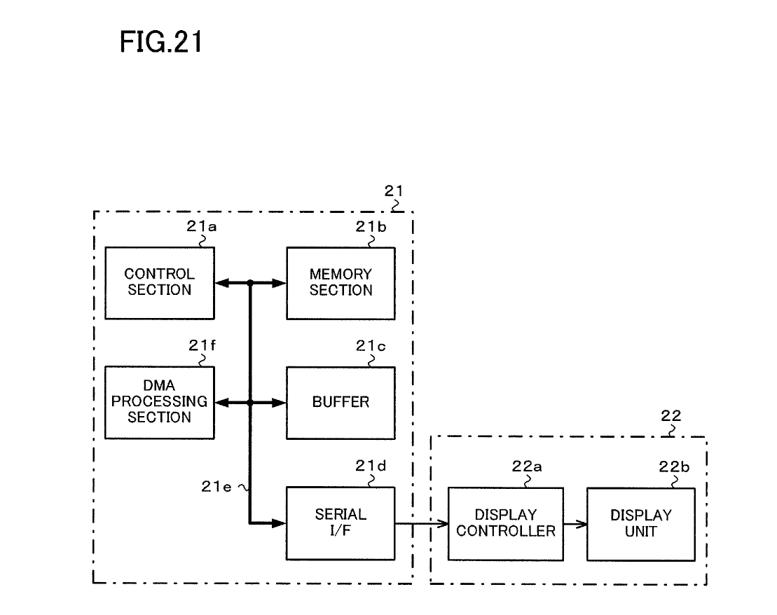

In the embodiments above, the control section 21a reads unit data P(x, y) constituting the digital data PD that is stored in the memory section 21b, and outputs that data to the buffer 21c. The invention is not limited to this, and it is also possible for the control unit 21, as illustrated in FIG. 21 to be provided with a DMA (Direct Memory Access) processing section 21f that performs DMA processing, and for that DMA processing section 21f to read unit data P(x, y) from the memory section 21b and output that data to the buffer 21c. In this case, the control section 21a does not need to perform read and output processing of the unit data P(x, y). Therefore, the load on the control section 21a can be further reduced.

In the embodiments above, cases were explained where the digital image had 2 gradations (1 bit) or 4 gradations (2 bits). The invention is not limited to this, and it is also possible for the digital image to be an image having 16 gradations (4 bits), 256 gradations (8 bits) or the like.

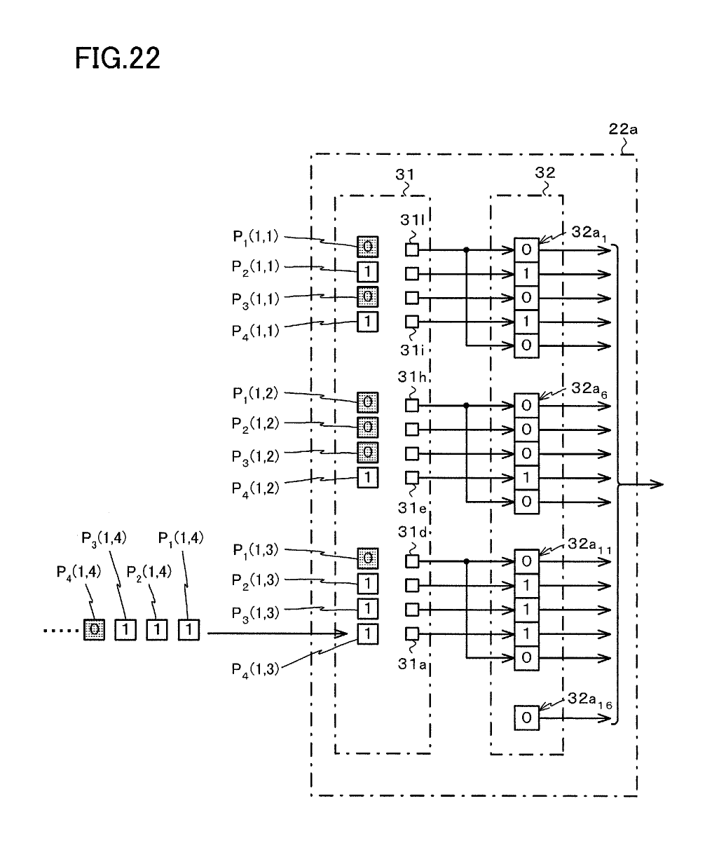

In the case of a digital image having 16 gradations, four unit data P₁(x, y) to P₄(x, y) are assigned to the pixels PX constituting the digital image. In this case, as illustrated in FIG. 22 for example, the flip-flop circuit 31 has twelve output stages 31a to 31l. The output stages 31a, 31b, 31c, 31e, 31f, 31g, 31i, 31j, and 31k are respectively connected to the output stages 32a₁₄, 32a₁₃, 32a₁₂, 32a₉, 32a₈, 32a₇, 32a₄, 32a₃ and 32a₂ of the buffer circuit 32. Moreover, the output stages 31d, 31h, and 31l of the flip-flop circuit 31 are respectively connected to output stage 32₁₅ and output stage 32a₁₁, output stage 32a₁₀ and output stage 32a₆, and output stage 32a₅ and output stage 32a₁ of the buffer circuit 32.

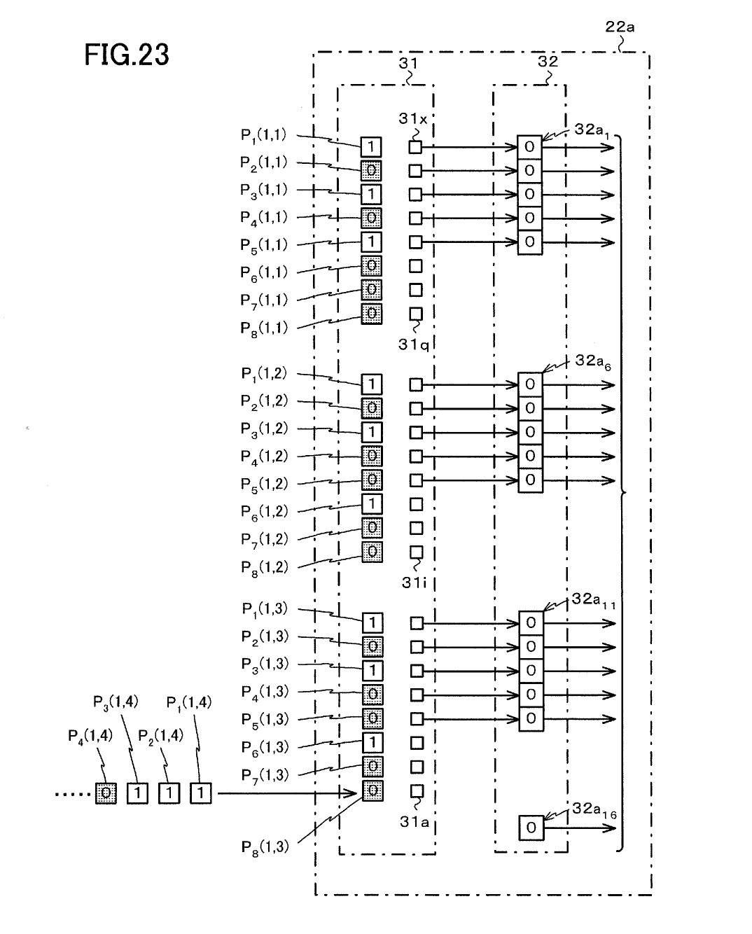

In the case of a digital image having 256 gradations, eight unit data P₁(x, y) to P₈(x, y) are assigned to the pixels PX constituting the digital image. In this case, as illustrated in FIG. 23 for example, the flip-flop circuit 31 has 24 output stages 31a to 31x. The output stages 31d to 31h are respectively connected to the output stages 32a₁₅, 32a₁₄, 32a₁₃, 32a₁₂, and 32a₁₁ of the buffer circuit 32. Moreover, the output stages 31l to 31p of the flip-flop circuit 31 are respectively connected to output stages 32a₁₀, 32a₉, 32a₈, 32a₇, and 32a₆ of the buffer circuit 32. Furthermore, the output stages 31t to 31x of the flip-flop circuit 31 are respectively connected to output stages 32a₅, 32a₄, 32a₃, 32a₂, and 32a₁ of the buffer circuit 32.

In each of the embodiments above, the case was explained where the remote-control device 20 performs control of the air-conditioning device 50, however the present invention is not limited to this. Moreover, the control unit 21 and display unit 22 of the embodiments may be used in devices other than a remote-control device such as a communication terminal as typified by a mobile telephone.

The present invention can undergo various embodiments and variations without departing from the wide spirit and scope of the invention. Moreover, the embodiments mentioned above are for explaining the invention, and do not limit the scope of the invention. In other words, the scope of the present invention is as disclosed in the claims and not the embodiments. Various variations of the invention that are carried out within the scope of the claims and the equivalent scope of the meaning of the invention are taken to be within the scope of the invention.

This application claims priority based on Japanese Patent Application No 2010-115106 filed on May 19, 2010. The entire description, claims, and drawings of the Japanese Patent Application No 2010-115106 are incorporated herein by reference.

### INDUSTRIAL APPLICABILITY

A data output device of the present invention is suitable for output of data that defines a digital image. Moreover, a display device and a display method of the present invention are suitable for displaying an image. Furthermore, a remote-control device of the present invention is suitable for controlling an operated device.

### DESCRIPTION OF REFERENCE NUMERALS

10 Air-conditioning system
16 16 rows
20 Remote control device
21 Control unit
21a Control section
21b Memory section
21c Buffer
21d Serial interface
21e Bus
21f DMA processing section
22 Display unit
22a Display controller
22b Display unit
23 Input interface
24 External interface
25 Bus
31 Flip-flop circuit
31a to 31l Output stage
32 Buffer circuit
32a₁ to 32a₁₆ Output stage
33 Multiplexer
50 Air-conditioning device
DD Dummy data
P Unit data
PD Digital data
PX Pixel
T1 Terminal

1. A data output device comprising:
a extraction unit for extracting data that defines a digital image as first parallel data;
a transmission unit for transmitting the extracted data one bit at a time;
a receiving unit for receiving the transmitted data; and
a conversion unit for generating second parallel data by converting the received data to a plurality of bits of data for each one bit of data.

2. The data output device according to claim 1, wherein the extraction unit extracts the data in units of a plurality of bits.

3. The data output device according to claim 1, wherein the receiving unit is a flip-flop circuit.

4. The data output device according to claim 1, wherein the transmission unit operates in synchronization with a clock that is obtained by multiplying a clock that regulates the operation of the extraction unit.

5. A display device comprising:
the data output device according to claim 1; and
a display unit having a plurality of input lines to which the second parallel data is inputted, and that displays the digital image based on the second parallel data.

6. The display device according to claim 5 comprising an output unit for outputting dummy data to the input lines other than the input lines to which the data is inputted when the number of input lines is greater than the data constituting the second parallel data.

7. The display device according to claim 5 further comprising:
output lines for outputting the second parallel data to the input lines; wherein
at least part of the output lines are exposed to the outside.

8. The display device according to claim 7, comprising:
a selection unit for outputting the second parallel data that is outputted from the output lines to the input lines at a timing required by the display unit for each predetermined number of bits of data.

9. A display method for displaying a digital image comprising the steps of:
extracting data that defines the digital image as first parallel data;
transmitting the extracted data one bit at a time;
receiving the transmitted data; and
generating second parallel data by converting the received data to a plurality of bits of data for each one bit of data.

10. The remote control device comprising:
an interface for receiving an instruction from a user; and
the display device according to claim 5 that displays a digital image based on the instruction from the user.
